(19) United States
(12) Patent Application Publication
(10) Pub. No.: US 2026/0131867 A1
(43) Pub. Date: May 14, 2026

(54) UNIVERSAL SPLINE TO BE COUPLED TO THE HUB OF A WHEEL WITHOUT FASTENERS

(71) Applicant: Lyndall P. Kitrell, JR., San Marcos, TX (US)

(72) Inventor: Lyndall P. Kitrell, JR., San Marcos, TX (US)

(21) Appl. No.: 18/943,301

(22) Filed: Nov. 11, 2024

(51) Int. Cl. B62L 1/00; B60B 27/00; B60B 27/02

(52) U.S. Cl. CPC B62L 1/005; B60B 27/0052; B60B 27/023

(57) ABSTRACT

A brake rotor assembly is disclosed to be attached to each of first and opposite hub faces located at respective first and opposite sides of a wheel, such as the front wheel of a motorcycle, to apply a braking force thereto. Each brake rotor assembly includes a disc brake rotor connected to a hub face spline. A hub spool having a bearing bore within which to receive an axle of the wheel extends from each hub face. Each hub face spline has a spool mounting hole for the receipt therethrough of a hub spool. A locking ring holds the hub face spline in surrounding engagement with a respective hub spool such that the hub face splines are coupled by the hub spools to the first and opposite hub faces at the first and opposite sides of the wheel without the use of heavy bolts.

### BACKGROUND OF THE INVENTION

### Field of the Invention

This invention relates to a wheel, such as a front wheel for a motorcycle, wherein the wheel has identical brake rotor assemblies coupled to opposite faces of the wheel hub to apply braking forces to opposite sides of the wheel. Each of the brake rotor assemblies has a disc brake rotor connected to a hub face spline that is coupled to a respective hub face of the wheel without the use of fasteners (e.g., bolts).

### Background Art

Some wheels that are used by a motorcycle are known to have a lug drive hub assembly that is mounted on the drive side of the wheel and a lug drive rotor assembly that is mounted on the opposite brake side of the wheel. The lug drive hub assembly includes a lug drive sprocket having a set of teeth around which a chain is wound to impart a rotational force to the sprocket that results in a corresponding rotation of the motorcycle wheel. The lug drive rotor assembly includes a lug brake rotor to which brake disk pads are attached to be used for applying a braking pressure against the wheel.

The conventional sprocket drive assembly and the conventional rotor brake assembly of a motorcycle commonly consist of components that are each connected to the wheel by means of a plurality of (e.g., five) bolts that are heavy and add weight to the wheel. Should either the drive or the rotor brake assembly require disassembly for the purposes of maintenance or replacement, all of the bolts must first be removed and then later reinstalled. Having to remove and reinstall a large number of bolts to make the repairs has been known to strip the bolt heads due to overtightening. Even making routine repairs requires special tools and the expenditure of time to remove and reinstall the bolts which adds to the inconvenience and the maintenance costs and may also damage the motorcycle wheel.

Accordingly, what would be desirable is the ability to attach axially aligned brake rotor assemblies to respective hub faces at opposite sides of the (e.g., front) wheel of a motorcycle without the use of heavy and time-consuming bolts or similar fasteners.

### SUMMARY OF THE INVENTION

In general terms, a monolithic wheel is described having particular application to be used as the front wheel for a motorcycle. The wheel has a hub at the center with a first brake rotor assembly attached to a first hub face at one side of the wheel to apply a braking force thereto. An identical brake rotor assembly is attached to the hub face at the opposite side of the wheel to apply an additional braking force to stop the wheel. The brake rotor assemblies are coupled to respective cylindrical hub spools that projects outwardly from the first and opposite hub faces by which the brake rotor assemblies are held in opposing axial alignment at opposite sides of the wheel. Each hub spool has a set of recessed channels running axially therealong between successive pairs of flanges. A set of grooves are formed in the flanges to extend circumferentially around the hub spool. A bearing bore extends axially through the hub spool to receive an axle of the wheel.

Each brake rotor assembly at each side of the wheel includes a hub face spline having a spool mounting hole running through the center. A set of mating tabs project into the mounting hole of the hub face spline. A corresponding set of flange catches are located between successive pairs of mating tabs and project outwardly from the mounting hole. A number of threaded fastener holes are formed in the hub face spline around the mounting hole thereof. A conventional disc brake rotor which has a spool receiving opening formed through the center thereof has a series of fastener holes formed around the spool receiving opening. Threaded fasteners are inserted through the fastener holes formed in the disc brake rotor for receipt by the threaded fastener holes found in the hub face spline, whereby the disc brake rotor is connected to the hub face spline.

The hub face spline of each of the identical brake rotor assemblies is positioned in surrounding and interlocking engagement with a respective cylindrical hub spool. In particular, the hub spool is received through the spool mounting hole of the hub face spline so that the flanges of the spool are located in respective flange catches of the spline and the mating tabs of the spline are received in respective channels of the spool. A locking ring is then snapped into surrounding engagement with the cylindrical hub spool within the grooves extending circumferentially therearound. The locking ring keeps the hub face spline in its surrounding engagement with the hub spool, whereby the spline is advantageously coupled to the hub face by way of the hub spool at one side of the wheel without the use of heavy bolts. At the same time, the face spline and the hub spool surrounded by the face spline are held in coaxial alignment with one another. As an additional advantage, the hub face spline of each brake rotor assembly can be coupled to different wheels made by different manufacturers so as to have a versatile universal characteristic.

### BRIEF DESCRIPTION OF THE DRAWINGS

FIG. 1 is an exploded view showing identical brake rotor assemblies to be connected to first and opposite faces of a hub at first and opposite sides of a wheel such as, for example, the front wheel of the motorcycle;

FIG. 2 is an exploded view to illustrate a hub face spline of one of the brake rotor assemblies of FIG. 1 to be removably coupled to the first hub face at the first side of the wheel without the use of fasteners;

FIG. 3 shows the hub face spline of the brake rotor assembly of FIG. 2 after being coupled to the first hub face of the wheel without the use of fasteners;

FIG. 4 is a top view of the hub face spline shown in FIG. 3;

FIG. 5 is taken in the direction of lines 5-5 of FIG. 2 to show a cylindrical hub spool that projects outwardly from the first hub face of the wheel to be surrounded by the hub face spline so that the spline is coupled by way of the spool to the first hub face without the use of fasteners;

FIG. 6 is a top view of an optional spacer that surrounds the cylindrical hub spool of FIG. 5 so as to lie between the hub face spline and the first hub face;

FIG. 7 is a perspective view of the wheel shown in FIG. 1 with the hub face spline removably coupled to the first hub face of the wheel without the use of fasteners;

FIG. 8 is a cross-section of the wheel shown in FIG. 7; and

FIG. 9 is a perspective view of the wheel showing the identical brake rotor assemblies connected in opposing axial alignment with one another at the first and opposite hub faces of the wheel.

### DESCRIPTION OF THE PREFERRED EMBODIMENT

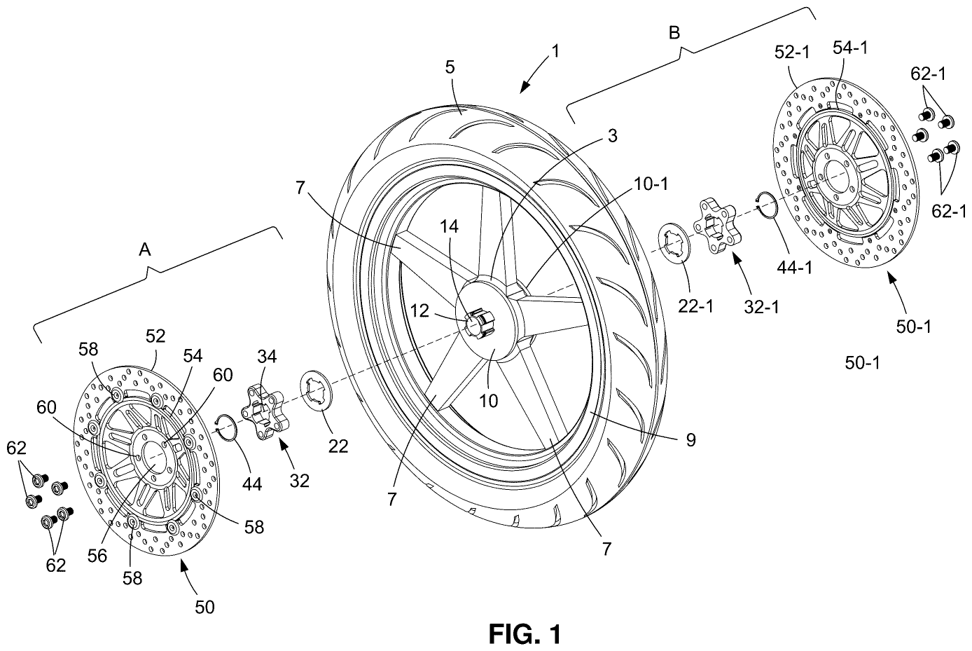

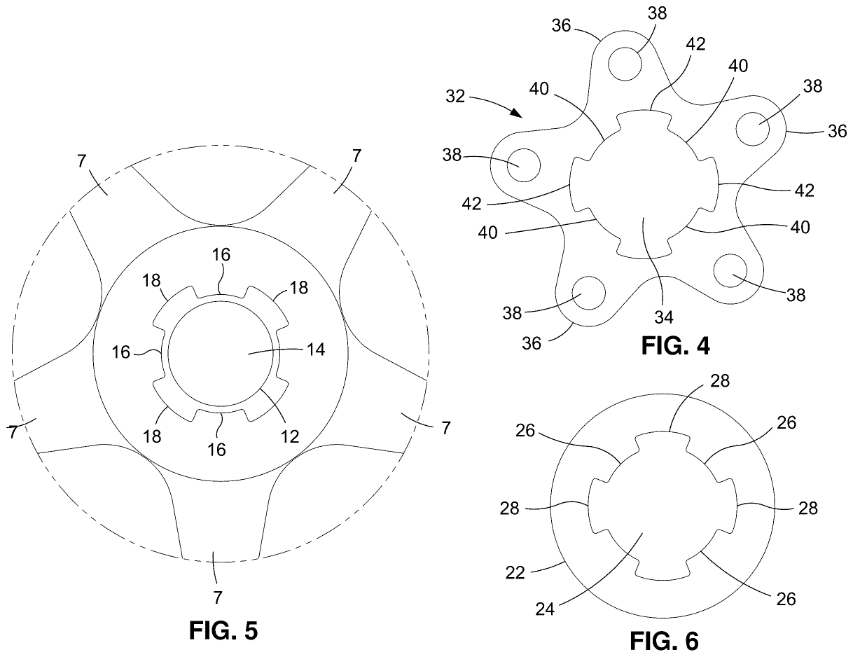

Referring concurrently to FIGS. 1-7 of the drawings there is shown a monolithic wheel 1 that is machined from a single piece of metal and that has application to be used as the front wheel of a motorcycle used for racing. However, it is to be understood that the particular vehicle and the application for which the wheel 1 is used should not be regarded as limitations of this invention. Located at the center of the wheel 1 is a hub 3 that is surrounded by a tire 5. A set of spokes 7 extends radially outward from the hub 3 to be connected to a rim 9 of the wheel 1 on which the tire 5 is mounted.

The hub 3 has opposing hub faces 10 and 10-1 located at first and opposite sides of the wheel 1. A brake rotor assembly A is mounted on the hub face 10 at the first side of the wheel to apply a braking force thereto, and an identical brake rotor assembly B is mounted on the hub face 10-1 at the opposite side of the wheel. A cylindrical hub spool 12 and 12-1 (best shown in FIG. 8) extends outwardly from each of the hub faces 10 and 10-1 at each of the opposite sides of the wheel 1. As will be described in greater detail hereinafter, the identical brake rotor assemblies A and B are held in opposing axial alignment with one another by the hub spools 12 and 12-1. Because the brake rotor assemblies A and B are identical, the details for the brake rotor assembly A only will be described. Therefore, similar reference numerals are used to refer to the identical features of both assemblies A and B.

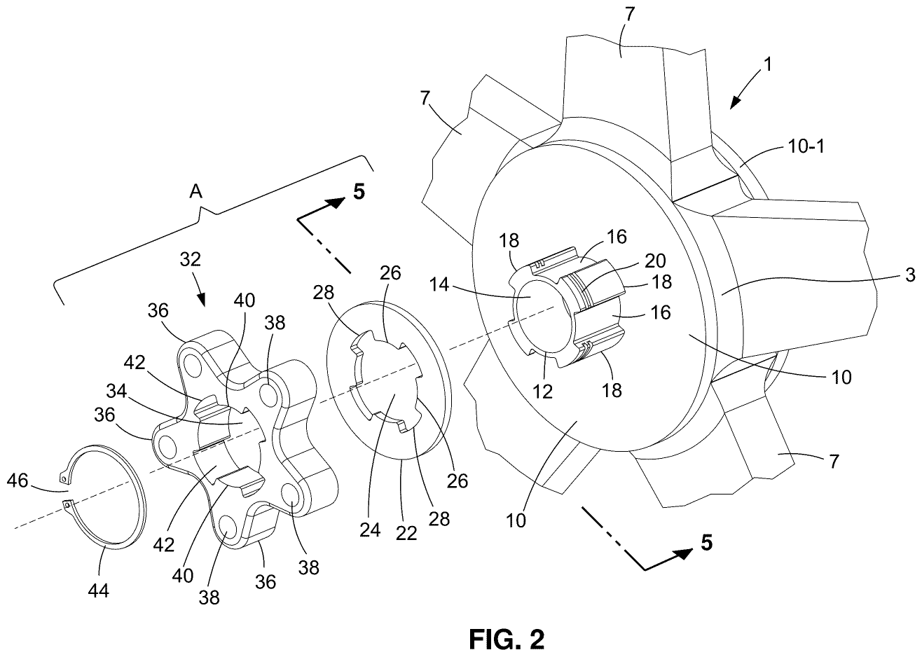

Running axially through the cylindrical hub spool 12 that projects from the hub face 10 is a bearing bore 14 within which a wheel axle and wheel bearings (not shown) are received so that the wheel 1 can be coupled to a motorcycle or other suitable vehicle. As is best shown in FIG. 2, a series of uniformly spaced recessed channels 16 run axially along the cylindrical hub spool 12. A corresponding series of uniformly spaced and raised flanges 18 run axially along the hub spool 12 between successive pairs of the channels 16. One or more grooves 20 are formed in each of the raised flanges 18 so as to run circumferentially around the outside of the cylindrical hub spool 12.

An optional disc-like spacer 22 has a through hole 24 formed at the center thereof to enable the spacer to be mated in surrounding engagement to the hub spool 12 at the first side of wheel 1. The spacer 22 is configured to have a series of uniformly spaced and radially inward extending mating tabs 26 that communicate with the through hole 24 and a corresponding series of uniformly spaced and radially outward extending flange catches 28 that are located between successive pairs of the mating tabs 26.

As an important feature of the brake rotor assembly A, a hub face spline 32 (best shown in FIG. 2) is shown to also be mated in surrounding engagement to the hub spool 12 at the first side of the wheel 1. The hub face spline 32 is shown having a generally star shape with a spool mounting hole 34 at the center and a series of arms 36 extending radially outward from the mounting hole. A threaded fastener hole 38 runs through each of the outstretched arms 36 of hub face spline 32. As in the case of the spacer 22, the spline 32 is configured to have a series of uniformly spaced and radially inward extending mating tabs 40 that communicate with the spool mounting hole 34 and a corresponding series of uniformly spaced and radially outward extending flange catches 42 that are located between successive pairs of the mating tabs 40.

As will now be described, a flexible locking ring 44 having a spring memory is provided by which the hub face spline 32 is removably coupled to the hub face 10 at the first side of the wheel 1. The locking ring 44 has a gap 46 located between opposite ends thereof to enable the ring to be momentarily spread open so as to be moved into interlocking engagement with hub spool 12.

More particularly, the optional spacer 22 is first located against the hub face 10 of the wheel hub 3 such that the cylindrical hub spool 12 is received through the hole 24 at the center of spacer 22. In this case, each of the mating tabs 26 of the spacer 22 slides downwardly and through a respective channel 16 located between a pair of flanges 18 of the hub spool 12. At the same time, each of the flange catches 28 of spacer 22 slides downwardly over and around a respective flange 18 located between a pair of channels 16 of the hub spool 12. Although only a single spacer 22 is shown in the drawings, any suitable number of spacers may be stacked together in the surrounding engagement with the hub spool 12 depending upon the size thereof.

Next, the hub face spline 32 is located over and against the spacer 22 such that the cylindrical hub spool 12 is also received through the spool mounting hole 34 at the center of the spline 32. In this case, each of the mating tabs 40 of the spline 32 slides downwardly through a respective channel 16 located between a pair of flanges 18 of the hub spool 12. At the same time, each of the flange catches 42 of spline 32 slides downwardly over and around a respective flange 18 located between a pair of channels 16 of the hub spool 12.

With the face spline 32 and the spacer 22 lying one over the other against the hub face 10 in surrounding engagement with the hub spool 12, the flexible locking ring 44 is snapped into locking engagement with the spool 12. In this case, the cylindrical hub spool 12 extends axially through each of the through hole 24 of the spacer 22 and the spool mounting hole 34 of the hub face spline 32 such that the set of grooves 20 that run circumferentially around the spool 12 are manually accessible. The locking ring 44 is pulled open at its gap so as to be able to slide over the hub spool 12 and snap into receipt by one of the grooves 20. The spring memory causes the locking ring 44 to automatically close within a groove 20 so as to hold the spacer 22 and the spline 32 firmly against the hub face 10.

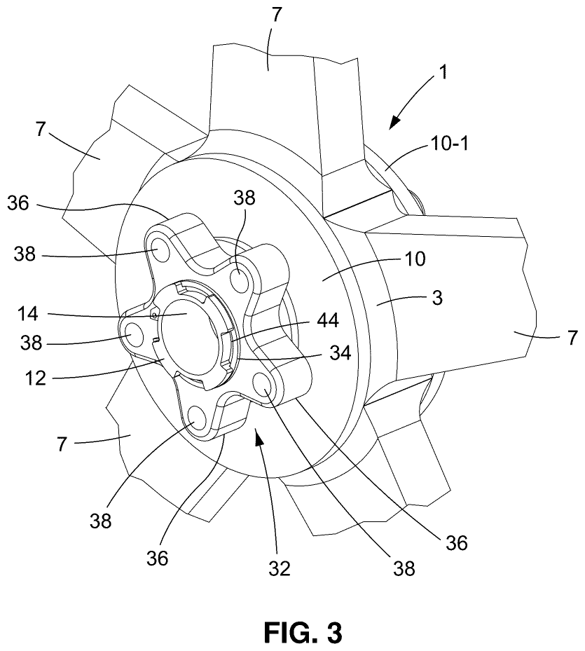

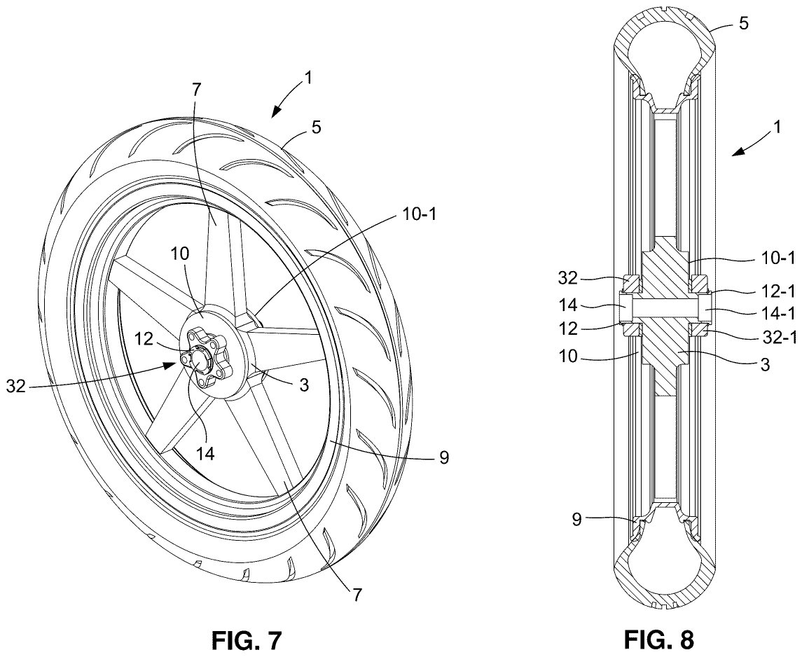

FIGS. 3 and 7 show the locking ring 44 after it has been snapped into locking engagement with the hub spool 12 that extends from the hub face 10 at the first side of wheel 1. As an important advantage of this invention, it should be appreciated that the spline 32 is coupled to the face 10 of the hub 3 of the wheel 1 without the connection thereto of bolts or other fasteners. Conventional brake rotors are commonly connected to a hub face by means of five or more heavy bolts. The use of such bolts adds weight to the wheel, which is particularly undesirable when the wheel is used on a motorcycle for racing. Moreover, the time required to install or remove the multiple bolts as well as the cost and complexity of the assembly are undesirable increased as is the machining of the wheel that is necessary to accommodate the bolts. Unlike conventional brake rotors, the hub face spline 32 disclosed herein may be relatively quickly and easily uncoupled and removed from the hub 3 for repair or replacement by simply opening and removing the locking ring 44.

As another important advantage of this invention, the hub face spline 32 is adapted to be used on wheels made by different manufacturers. Accordingly, the versatility of the hub face spline 32 is enhanced, such that it is provided with a “universal” characteristic.

Returning to FIG. 1, there is shown a conventional disc brake rotor 50 to be connected to the hub face 10 so as to complete the brake rotor assembly A by which a breaking force can be applied to the first side of the wheel 1. The disc brake rotor 50 includes an outer friction ring 52 that surrounds an inner carrier ring 54 having a spool receiving opening 56 at the center thereof. The inner carrier ring 54 is connected to the outer friction ring 52 by a plurality of rivets 58 that are evenly spaced from one another around the rotor 50.

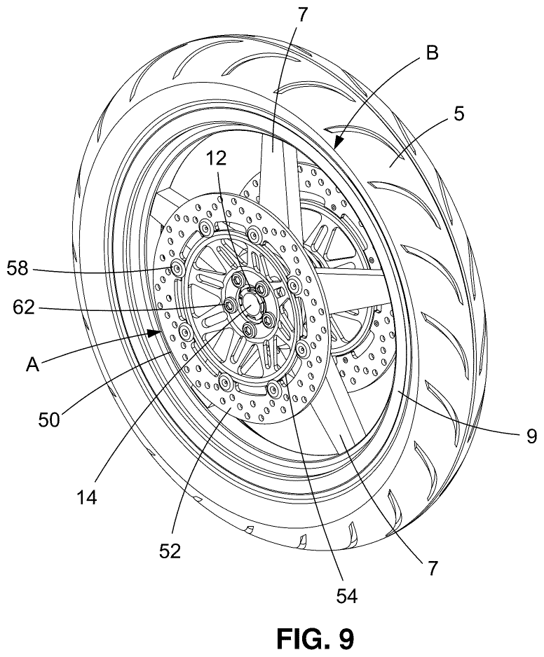

A plurality of holes 60 are formed in the inner carrier ring 54 to accommodate therethrough a corresponding plurality of threaded fasteners 62. As is best shown in FIGS. 1 and 9, the threaded fasteners 62 are moved through the holes 60 in the inner carrier ring 54 for receipt by respective ones of the threaded fastener holes 38 that are formed in the hub face spline 32, whereby the disc brake rotor 50 is connected to the hub face spline 32 at the first side of the wheel 1.

The spool receiving opening 56 at the center of the disc brake rotor 50 is now held in axial alignment with the bearing bore 14 of the hub spool 12, and the hub face spline 32 is concentrically aligned with the cylindrical hub spool that is surrounded by the spline 32. Inasmuch as the cylindrical hub spool 12 extends from the face 30 of hub 3 through the spool mounting hole 34 of the hub face spline 32 and into the spool receiving opening 56 of the disc brake rotor 50, a wheel axle (not shown) can be inserted through the bearing bore 14 of the cylindrical hub spool 12 to impart a rotational force to the wheel 1.

Because the disc brake rotor 50 is connected by fasteners 62 to the hub face spline 32 and the spline 32 is coupled by means of the hub spool 12 to the hub 3, the wheel 1, the hub face spline 32 and the disc brake rotor 50 are connected together. In this same regard, FIG. 8 of the drawings shows the opposing hub spools 12 and 12-1 integrally connected to each other as one piece so as to extend axially and continuously through the hub 3. Therefore, the brake rotor assemblies A and B at opposite sides of the monolithic wheel 1 are rotated simultaneously with one another.

FIG. 9 of the drawings shows the monolithic wheel 1 with the identical brake rotor assemblies A and B removably attached as mirror images of one another at the opposite sides of the wheel. As previously described, the hub spools 12 and 12-1 maintain the brake rotor assemblies A and B in opposing axial alignment so that an axle can be located through the bearing bores 14 and 14-1, whereby a rotational force can be imparted from the axle to the wheel.

1. A wheel, comprising:
a hub located at the center of the wheel and having first and opposite hub faces at respective first and opposite sides of the wheel;
a rim surrounding the hub on which a tire is to be mounted;
a disc brake rotor to apply a braking force to the wheel; and
a hub face spline to which said disc brake rotor is connected, said hub face spline coupled to the first of said first and opposite hub faces at the first side of the wheel without the use of fasteners being connected to said hub face spline to couple said hub face spline thereto.

2. The wheel recited in claim 1, wherein said disc brake rotor has a first set of fastener receiving holes formed therein and said hub face spline has a second set of fastener receiving holes formed therein, said wheel further comprising a set of fasteners extending through respective ones of said first and second fastener receiving holes, whereby said disc brake rotor is connected to said hub face spline.

3. The wheel recited in claim 1, wherein said hub face spline is removable from the first hub face of said hub.

4. The wheel recited in claim 1, further comprising a hub spool extending from the first hub face of said hub at the first side of said wheel, said hub face spline being mated to said hub spool by which said hub face spline is coupled without the use of fasteners connected thereto to said first hub face.

5. The wheel recited in claim 4, wherein said hub face spline has a spool mounting hole formed therein through which said hub spool is received such that said hub face spline is connected in surrounding engagement to said hub spool and said hub face spline is thereby coupled without the use of fasteners connected thereto to said first hub face.

6. The wheel recited in claim 5, wherein said hub spool has at least one flange and said hub face spline has at least one flange catch that communicates with the spool mounting hole thereof, said flange being located within said flange catch when said hub spool is received through the spool mounting hole of said hub face spline, whereby said hub face spline is connected in said surrounding engagement to said hub spool.

7. The wheel recited in claim 5, wherein said hub face spline has at least one mating tab that communicates with the spool mounting hole thereof and said hub spool has at least one channel formed therein, said mating tab being located within said channel when said hub spool is received through the spool mounting hole of said hub face spline, whereby said hub face spline is connected in said surrounding engagement to said hub spool.

8. The wheel recited in claim 5, wherein said hub spool has a bore running axially therethrough such that said hub face spline and said hub spool are coaxially aligned with one another when said hub spool is received through the spool mounting hole formed in said hub face spline.

9. The wheel recited in claim 5, further comprising a locking ring attached in surrounding engagement to said hub spool received through the spool mounting hole formed in said hub face spline by which said hub face spline is maintained in said surrounding engagement to said hub spool and said hub face spline is thereby coupled without the use of fasteners connected thereto to said first hub face.

10. The wheel recited in claim 9, wherein said locking ring is removably attached to said hub spool such that said hub face spline is removable from being connected in said surrounding engagement to said hub spool.

11. The wheel recited in claim 9, wherein said hub spool has a groove formed therein and extending therearound within which to receive said locking ring such that said locking ring is attached in said surrounding the engagement to said hub spool.

12. A wheel, comprising:
a hub located at the center of the wheel and having first and opposite hub faces at respective first and opposite sides of the wheel;
first and second disc brake rotors to apply a braking force to the first and opposite sides of the wheel; and
first and second hub face splines to which said first and second disc brake rotors are respectively connected, said first and second hub face splines being coupled to respective ones of said first and opposite hub faces at the first and opposite sides of the wheel without the use of fasteners being connected to said hub face splines to couple said hub face splines thereto.

13. The wheel recited in claim 12, further comprising a hub spool extending from each of the first and opposite hub faces of the hub to which said first and second hub face splines are respectively coupled, said first and second hub face splines being mated to respective ones of said hub spools so as to be coupled without the use of fasteners connected thereto to said first and opposite hub faces by said hub spools.

14. The wheel recited in claim 13, wherein the hub spools extending from the first and opposite hub faces are integrally connected to one another so as to run axially and continuously through the hub of the wheel.

15. The wheel recited in claim 13, wherein each of said first and second hub face splines has a spool mounting hole formed therein through which respective ones of said hub spools are received such that said hub face splines are connected in surrounding engagement to said hub spools such that said hub face splines are coupled without the use of fasteners connected thereto to respective ones of said first and opposite hub faces at the first and opposite sides of the wheel.
